(19) United States
(12) Patent Application Publication
(10) Pub. No.: US 2007/0290475 A1
(43) Pub. Date: Dec. 20, 2007

(54) Step light

(76) Inventor: Jack Reitinger, Torrance, CA (US)

Correspondence Address: The Patent Law Offices of Walter L. Beavers, 326 South Eugene Street, Greensboro, NC, 27401, US

(21) Appl. No.: 11/455,603

(22) Filed: Jun. 19, 2006

(51) Int. Cl. B60R 3/00

(52) U.S. Cl. 280/164.1

(57) ABSTRACT

A step light for a vehicle or trailer having entry steps, comprising an electroluminescent light panel, a housing adapted to hold the electroluminescent panel, a cover for the electroluminescent panel also held in the housing, means to electrically connect the electroluminescent panel to a power source.

### BACKGROUND OF THE INVENTION

Recreational vehicles (RVs), trucks, vans, busses and other large vehicles often have steps leading up to the door of the vehicle. Often, these vehicle steps protrude out of the vehicle. Also, these vehicles are often parked in dark areas where it is difficult to see the steps. Often, children, the elderly and physically challenged persons are using the steps. A light on the steps makes the steps and surrounding area visible in low-light conditions and increases greatly the safety in the use of the steps, when entering or leaving the vehicle.

While lighted steps and running boards are known, such as described in U.S. Pat. No. 6,709,137, they are often very complex and manufactured as a part of the step or are not provided at all. A need exists for a simple, low power draw, high visbility step light which may easily be installed on existing steps.

### SUMMARY OF THE INVENTION

This invention comprises a step light that lights the steps of any RV or trailer, as well as other vehicles having stairs. The step light of this invention attaches to the riser of almost any vehicle or trailer step and requires no drilling to mount. The step light is attached using automotive double-sided tape.

The step light may be tied into almost any set of automatic steps or any 12 vdc power source, making only two wire connections. This enables the step light to turn on when the steps are deployed and off when the steps retract, when installed on automatic steps or tied into any type of switch for manual operation.

The step light is low profile and provides an even source of light along the entire length of the step. The step light may be operated with any 12 vdc power source in conjunction with a switch to light even non-electric steps. It is also extremely durable and extremely water resistant and will withstand heavy rains and water.

### OBJECTS OF THE INVENTION

It is an object of the present invention to provide a lighting device for vehicle steps that are easy to install and shed considerable light on the steps and the ground surface.

It is a further object of the invention to provide a lighting device for vehicle steps that may be operated by the electrical system of the vehicle or may be operated by any 12 vdc power source.

### BRIEF DESCRIPTION OF THE DRAWINGS

The above stated objects and other advantages of the invention will be explained by reference to following detailed description when considered along with the attached drawings wherein:

FIG. 1 is a perspective view of the lighting device attached to a set of steps;

FIG. 2 is an exploded view of the lighting device; and,

FIG. 3 is an assembled view of the lighting device.

### DETAILED DESCRIPTION OF THE PREFERRED EMBODIMENT OF THE INVENTION

Referring now to FIGS. 1-3 there is shown, a set of RV entry (and exit) steps 10 comprising upper step 12 and lower step 14. The set of steps 10 is attached to a recreational vehicle 16. The lighting device of this invention 18 and 20 is shown affixed to the riser 22 of step 12 and the riser 24 of step 14.

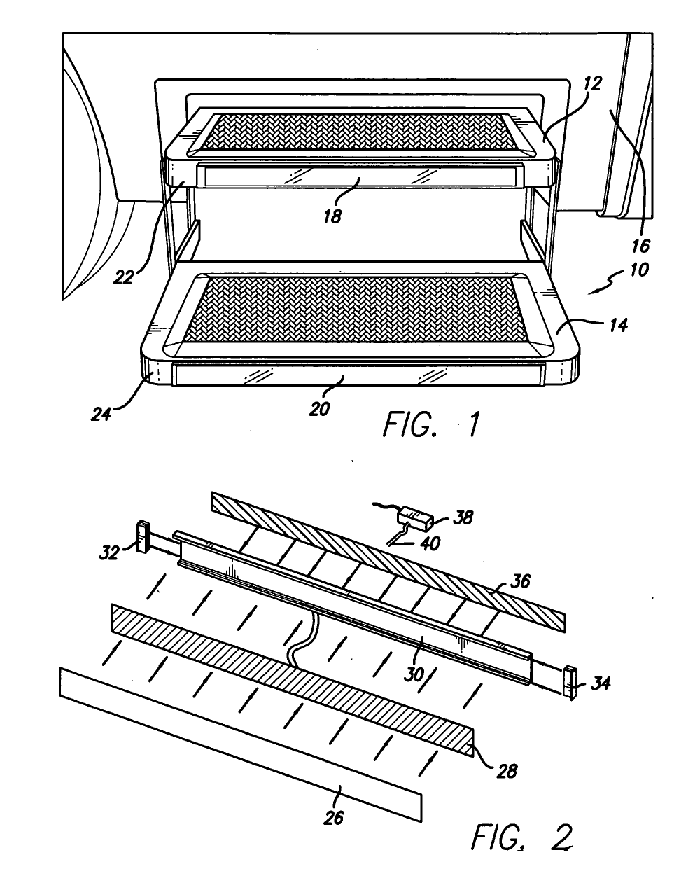

Referring specifically to FIG. 2 the lighting device comprises a cover 26, electroluminescent light panel 28, and housing 30, adapted to hold electroluminescent panel 28, the electric lighting panel. Cover 26 is preferably clear and may be made of any material, such as plastic or glass. A particularly good plastic material is Lexan polycarbonate, due to its clarity and its ability to withstand impact. Cover 26 is optional, in that it is not required, but is recommended for protection of electroluminescent light panel 28. Also, cover 26 may be colored if it is desired to have the light on the steps glow with a particular color.

Electroluminescent light panel 28 is also known as a light emitting capacitor.

End caps 32 and 34 are inserted into the ends of housing 30 after electric lighting panel 28 and cover 26 are inserted, to hold them securely, so that they do not slide out of housing 30.

Double-sided tape 36 is attached to the back of housing 30 and is utilized to affix the lighting device to the riser of each of the steps. The lighting device may be affixed to one or more or all of the steps as desired. Other means of attaching the housing to the steps may be used, such as an adhesive, tape or any other convenient method of attachment. Double-sided tape is preferred due to its ease of use.

An inverter 38, adapted to be plugged into the electrical system of the RV, is attached by wires 40 through housing 30 to electric lighting panel 28.

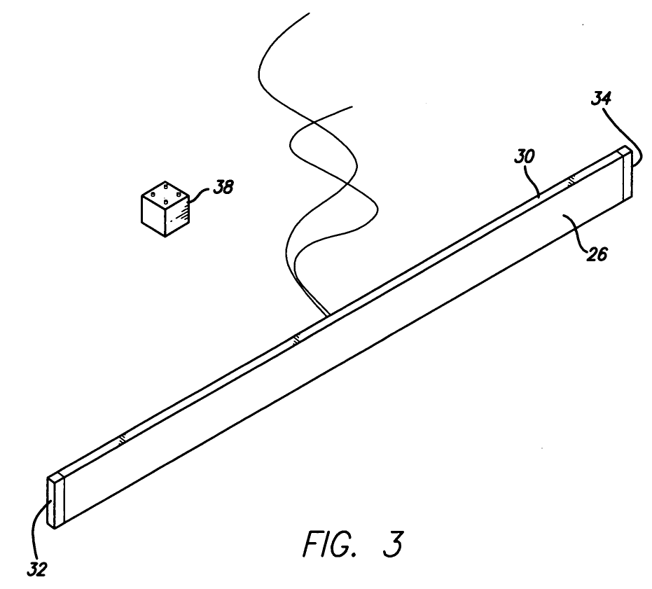

FIG. 3 shows the lighting device of this invention as assembled.

Electroluminescent light panel 28 is a panel which lights up along its entire length when power is connected and is manufactured by various companies including Thousand Values Limited Company of China.

Inverter 38, which is designed to operate with 12 volt DC input, common in most vehicles and trailers, is remotely installed near the controls for the steps in those vehicles that have automatic steps and the inverter is then connected by wire to the panel and housing controls for the automatic steps, so that the light goes on when the steps are lowered and the light goes off when the steps are raised.

In the event the lighting device is being operated by an independent 12 vdc power source, the lighting device, in this case, is not connected to an automatic stair control and would then be wired with a switch to turn the lighting device on and off. An indicator light, such as an LED, may be present on the housing of the battery pack to show when the lighting device is turned on.

The lighting device of the present invention fits most stairs of recreational vehicles, trailers and the like and adds safety for entry and exit of the vehicle or trailer. It provides even light distribution across the entire step. It has a low power draw and an extremely long life, in excess of 20,000 hours. The device is weather resistant and impervious to heavy rain. No drilling or other extensive installation is required. The device is attached to the riser of the steps by a double-sided tape such as one manufactured by 3M.

Having thus described the invention, I claim:

1. A step light for a vehicle or trailer having entry steps, comprising an:
electroluminescent panel, a housing adapted to hold the electroluminescent panel, means to attach the housing to the entry steps and means to electrically connect the electroluminescent panel to a power source.

2. The step light of claim 1 in which the power source is the electrical system of the vehicle or trailer.

3. The step light of claim 1 in which the power source is one or more batteries.

4. The step light of claim 1 in which the housing has an end cap at each end of the housing.

5. The step light of claim 1 further comprising a cover for the electroluminescent panel in which he cover is also held in the housing.

6. The step light of claim 5 in which the cover is clear.

7. The step light of claim 5 in which the cover is colored.

8. The step light of claim 6 in which the cover is made of plastic or glass.

9. The step light of claim 3 further comprising a switch to turn the step light on and off.

10. The step light of claim 9 further comprising an indicator light to indicate when the step light is on or off.

11. The step light of claim 1 in which the means to attach the housing to the entry steps is double-sided tape.

12. A step light for a vehicle or trailer having entry steps which raise and lower automatically by a power source within the vehicle or trailer comprising, an electroluminescent panel, a housing adapted to hold the electroluminescent panel, a cover for the electroluminescent panel also held in the housing, means to electrically connect the electroluminescent panel to the power source for the automatic steps, so that the step light goes on when the steps are lowered and goes off when the steps are raised, and means to connect the housing to the steps.

13. A step light for a vehicle or trailer having a plurality of entry steps, each step having a riser, which entry steps raise and lower automatically using a power source of the vehicle or trailer comprising, an elongated electroluminescent panel adapted to fit on the riser, a housing adapted to hold the electroluminescent panel, a clear cover for the electroluminescent panel also held in the housing, an end cap at each end of the housing, means to electrically connect the electroluminescent panel to the power source for the automatic steps, so that the step light goes on when the steps are lowered and goes off when the steps are raised, double-sided tape attached to the rear of the housing for attachment to the riser of the steps.

14. The step light of claim 13 in which a step light is affixed to each entry step riser.

15. The step light of claim 13 in which the vehicle is a recreational vehicle.

16. The step light of claim 13 in which the entry steps are to a trailer.

17. The step light of claim 13 in which the entry steps are to any vehicle equipped with steps.
